(19) United States
(12) Patent Application Publication
(10) Pub. No.: US 2017/0220120 A1
(43) Pub. Date: Aug. 3, 2017

(54) SYSTEM AND METHOD FOR CONTROLLING PLAYBACK OF MEDIA USING GESTURES

(71) Applicant: Thomson Licensing SYSTEM, Issy les Moulineaux (FR)

(72) Inventors: Shaun Kohei WESTBROOK, West Hollywood, CA (US); Juan M. NOGUEROL, Gardena, CA (US)

(21) Appl. No.: 15/110,398

(22) PCT Filed: Jan. 7, 2015
(86) PCT No.: PCT/US2015/010492

§ 371 Date: Jul. 7, 2016

Related U.S. Application Data
(60) Provisional application No. 61/972,954, filed on Mar. 31, 2014.
(60) Provisional application No. 61/924,647, filed on Jan. 7, 2014.

(51) Int. Cl. G06F 3/01; H04N 21/4223; H04N 21/472; H04N 21/442; G11B 27/00; G06K 9/00

(52) U.S. Cl. CPC G06F 3/017; G11B 27/005; G06K 9/00355; H04N 21/47217; H04N 21/44218; H04N 21/4223

(57) ABSTRACT

The playback of media by a playback device is controlled by input gestures. Each user gesture can be first broken down into a base gesture which indicates a specific playback mode. The gesture is then broken down into a second part which contains a modifier command which determines the speed for the playback mode determined from the base command. Media content is then played using the specified playback mode at a speed determined by the modifier command.

### REFERENCE TO RELATED APPLICATIONS

This application claims the benefit of U.S. Provisional Application Ser. No. 61/924,647 filed Jan. 7, 2014 and U.S. Provisional Application Ser. No. 61/972,954 filed Mar. 31, 2014 which are incorporated by reference herein in their entirety.

### TECHNICAL FIELD OF THE INVENTION

The present disclosure generally relates to the control of the playback of media, specifically the control of the playback of media using gestures.

### BACKGROUND OF THE INVENTION

In the control of media such as video or audio, a user typically uses a remote control or buttons to control the playback of such media. For instance, a user can press a “play” button to cause media to be played back from a playback device such a computer, receiver, MP3 player, phone, tablet, and the like to have media played in a real time play mode. When a user wants to jump ahead to a portion of the media, the user can activate a “fast forward” button to cause the playback device to advance the media in a faster than real time play mode. Likewise, the user can activate a “fast reverse button” to cause the playback device to reverse the media in a faster than real time play mode.

In order to move away from the use of a remote control or the use of buttons on a playback device, a device can be implemented to recognize the use of gestures to control the playback of a device. That is, the gestures can be recognized optically by a user interface part of the device where the gestures are interpreted by the device to control media playback. With the multiplicity of playback modes and speeds that can be used for such modes, it is likely that a device manufacturer would require a user to remember many gesture commands in order to control the playback of media.

### SUMMARY

A method and system are disclosed for controlling the playback of media for a playback device using gestures. A user gesture is first broken down into a base gesture which indicates a specific playback mode. The gesture is then broken down into a second part which contains a modifier command which modifies the playback mode determined from the base command. The playback mode is then affected by the modifier command where, for example, the speed of the playback mode can be determined by the modifier command.

### BRIEF DESCRIPTION OF THE DRAWINGS

These and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 is an exemplary illustration of a system for gesture spotting and recognition according to an aspect of the present disclosure;

FIG. 2 is a flow diagram of an exemplary method for gesture recognition according to an aspect of the present disclosure;

FIG. 3 is a flow diagram of an exemplary method for gesture spotting and recognition according to an aspect of the present disclosure;

FIG. 4 illustrates examples of state transition points extracted from a segmented trajectory “0” performed by a user;

FIG. 5 is a flow diagram of an exemplary method for training a gesture recognition system using Hidden Markov Models (HMM) and geometrical feature distributions according to an aspect of the present disclosure;

FIG. 6 is a flow diagram of an exemplary embodiment for adapting a gesture recognition system to a specific user according to an aspect of the present disclosure;

FIG. 7 is a block diagram of an exemplary playback device according to an aspect of the present disclosure;

FIG. 8 is a flow diagram of an exemplary embodiment for determining input gestures that are used to control the playback of media according to an aspect of the present disclosure;

FIG. 9 is a representation of a user interface showing an representation of an arm and hand user input gesture for controlling a playback of media according to an aspect of the present disclosure;

FIG. 10 is a representation of a user interface showing an arm and hand user input gesture for controlling a playback of media according to an aspect of the present disclosure; and

FIG. 11 is a representation of a user interface showing an arm and hand user input gesture for controlling a playback of media according to an aspect of the present disclosure.

It should be understood that the drawing(s) is for purposes of illustrating the concepts of the disclosure and is not necessarily the only possible configuration for illustrating the disclosure.

### DETAILED DESCRIPTION OF THE DISCLOSURE

It should be understood that the elements shown in the figures can be implemented in various forms of hardware, software or combinations thereof. Preferably, these elements are implemented in a combination of hardware and software on one or more appropriately programmed general-purpose devices, which may include a processor(s), memory and input/output interfaces.

The present description illustrates the principles of the present disclosure. It will thus be appreciated that those skilled in the art will be able to devise various arrangements that, although not explicitly described or shown herein, embody the principles of the disclosure and are included within the scope of the disclosure.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

The disclosure provides an exemplary embodiment for implementing various gesture recognition systems, although other implementations for recognizing gestures can be used. Systems and methods are also provided employing Hidden Markov Models (HMM) and geometrical feature distributions of a hand's trajectory of a user to achieve adaptive gesture recognition.

Gesture recognition is receiving more and more attention due to its potential use in sign language recognition, multimodal human computer interaction, virtual reality and robot control. Most gesture recognition methods match observed sequences of input images with training samples or a model. The input sequence is classified as the gesture class whose samples or model matches it best. Dynamic Time Warping (DTW), Continuous Dynamic Programming (CDP), Hidden Markov Model (HMM) and Conditional Random Field (CRF) are examples of gesture classifiers.

HMM matching is the most widely used technique for gesture recognition. However, this kind of method cannot utilize geometrical information of a hand's trajectory, which has proven effective for gesture recognition. In previous methods utilizing hand trajectory, the hand trajectory is taken as a whole, and some geometrical features which reflect the shape of the trajectory, such as the mean hand's position in the x and y axis, the skewness of x and y positions of the observed hands, and so on, are extracted as the input of the Bayesian classifier for recognition. However, this method cannot describe the hand gesture precisely.

For online gesture recognition, gesture spotting, i.e., determining the start and end points of the gesture, is a very important but difficult task. There are two types of approaches for gesture spotting: the direct approach and the indirect approach. In direct approaches, motion parameters, such as velocity, acceleration and trajectory curvature, are first computed, and abrupt changes of these parameters are found to identify candidate gesture boundaries. However, these methods are not accurate enough. The indirect approaches combine gesture spotting and gesture recognition. For the input sequence, the indirect approaches find intervals that give high recognition scores when matched with training samples or models, thus achieving temporal segmentation and recognition of gestures at the same time. However, these methods are usually time-consuming, and also some false detection of gestures may occur. One conventional approach proposes to use a pruning strategy to improve the accuracy as well as speed of the system. However, the method simply prunes based on the compatibility between a single point of the hand trajectory and a single model state. If the likelihood of the current observation is below a threshold, the match hypothesis will be pruned. The pruning classifier based on this simple strategy may easily over fit the training data.

Furthermore, different users' gestures usually differ in speed, starting and ending points, angles of turning points and so on. Therefore, it's very meaningful to study how to adjust the classifiers to make a recognition system adapt to specific users.

Previously, only a few researchers have studied adaptive gesture recognition. One technique achieves the adaptation of a gesture system through retraining the HMM models with new samples. However, this method loses the information of previous samples and is sensitive to noise data. Another technique uses an online version of the Baum-Welch method to realize online learning and updating of gesture classifiers, and develops a system that can learn a simple gesture online. However, the updating speed of this method is very slow.

Although there are only a few studies on adaptive gesture recognition, many methods for adaptive speech recognition have been published. One such study updates the HMM model through maximum a posteriori (MAP) parameter estimation. Through the use of prior distributions of parameters, less new data is needed to get robust parameter estimation and updating. The drawback of this method is that the new samples can only update the HMM model of its corresponding class, thus decreasing the updating speed. Maximum likelihood linear regression (MLLR) is widely used for adaptive speech recognition. It estimates a set of linear transformations of the model parameters using new samples, so that the model can better match the new samples after transformation. All model parameters can share a global linear transformation, or cluster into different groups, where each group of parameters shares a same linear transformation. MLLR can overcome the drawback of MAP, and improve the model updating speed.

For an input sequence, detected points of interest are matched with a HMM model and points are found where the states of HMM model change through a Viterbi algorithm or function. These points are called state transition points. The geometrical features are extracted from the gesture model based on the relative positions of state transition points and the starting point of the gesture. These geometrical features describe the hand gesture more precisely than the conventional methods. The state transition points usually correspond to the points where the trajectory begins to change, and extracting features based on the relative positions of these points and the starting point can reflect the characteristic of the gesture's shape very well, in contrast to conventional methods that take the hand trajectory as a whole and extract geometrical feature based on the statistical property of the hand trajectory.

Besides, as the extraction of the geometrical features is incorporated into the matching of HMM models, it is easy to utilize the extracted geometrical features for pruning, as well as to help recognize the type of the gesture. For example, if the likelihood of geometrical features extracted at a state transition point is below a threshold, this match hypothesis will be pruned. That is, if at some frame, it is determined that the cost of matching the frame to any state of a HHM model is too high, the system and method of the present disclosure concludes that the given model doesn't match the input sequence well and then it will stop matching subsequent frames to the states.

The incorporation of geometrical features for pruning is more accurate and robust than using only single observation. When a model matching score, which is computed based on a combination of HMM model and geometrical feature distributions between the hand trajectory and a gesture class, is bigger than a threshold, the gesture is segmented and recognized. This combination of detection of abrupt changes of motion parameters, HMM model matching and trajectory geometrical feature extraction outperforms the existing gesture spotting methods.

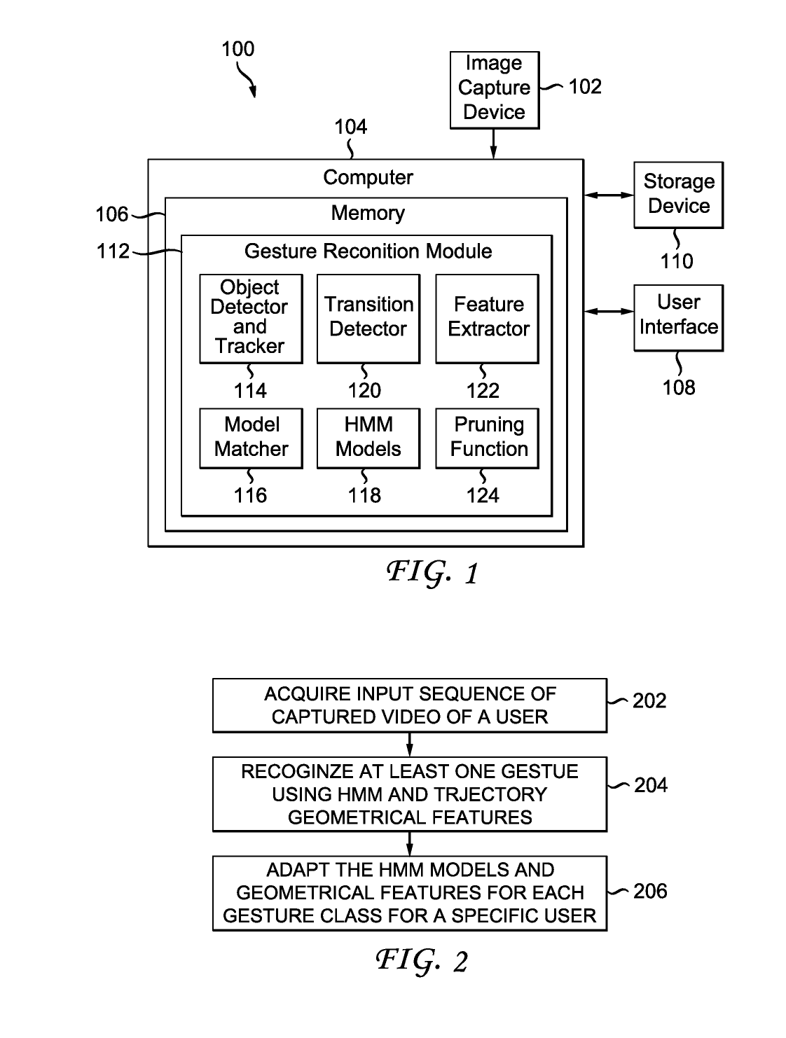

Referring now to the Figures, exemplary system components 100 according to an embodiment of the present disclosure are shown in FIG. 1. An image capture device 102 may be provided for capturing images of a user performing a gesture. It is to be appreciated that the image capture device may be any known image capture device and may include a digital still camera, a digital video recorder, a web cam, etc. The captured images are input to a processing device 104, e.g., a computer. The computer is implemented on any of the various known computer platforms having hardware such as one or more central processing units (CPU), memory 106 such as random access memory (RAM) and/or read only memory (ROM) and input/output (I/O) user interface(s) 108 such as a keyboard, cursor control device (e.g., a mouse or joystick) and display device. The computer platform also includes an operating system and micro instruction code. The various processes and functions described herein may either be part of the micro instruction code or part of a software application program (or a combination thereof) which is executed via the operating system. In one embodiment, the software application program is tangibly embodied on a program storage device, which may be uploaded to and executed by any suitable machine such as processing device 104. In addition, various other peripheral devices may be connected to the computer platform by various interfaces and bus structures, such a parallel port, serial port or universal serial bus (USB). Other peripheral devices may include additional storage devices 110 and a printer (not shown).

A software program includes a gesture recognition module 112, also know as a gesture recognizer, stored in the memory 106 for recognizing gestures performed by a user in a captured sequence of images. The gesture recognition module 112 includes an object detector and tracker 114 that detects an object of interest, e.g., hands of a user, and tracks the object of interest through a sequence of captured images. A model matcher 116 is provided to match the detected and tracked object to at least one HMM model stored in a database of HMM models 118. Each gesture type has a HMM model associated to it. The input sequence is matched with all the HMM models corresponding to different gesture types to find which gesture type matches the input sequence best. For example, given an input sequence which is a sequence of the features from each frame of the captured video and a gesture model which is a sequence of states, the model matcher 116 finds the corresponding relation between each frame and each state. The model matcher 116 may employ the Viterbi algorithm or function, a forward algorithm or function, a forward-backward algorithm or function, etc. to realize the matching.

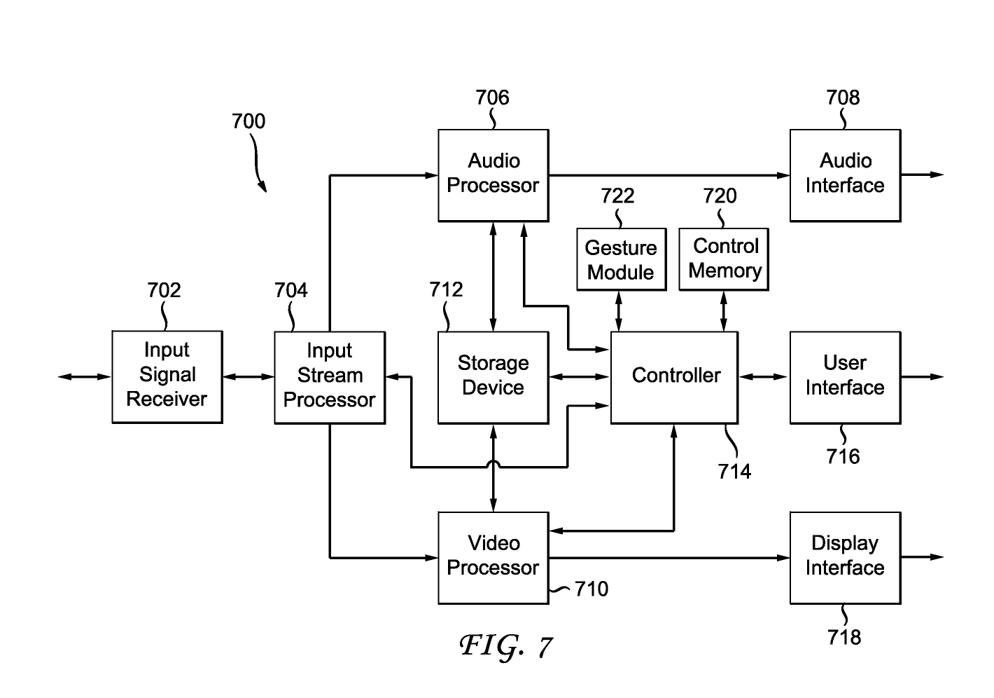

The gesture recognition module 112 (also referenced as 722 in FIG. 7) further includes a transition detector 120 for detecting points where the states of a HMM model change. These points are called state transition points and are found or detected through a Viterbi algorithm or function, among others, employed by the transition detector 120. Geometrical features are extracted based on the relative positions of state transition points and the starting point of the gesture by a feature extractor 122.

The gesture recognition module 112 further includes a pruning algorithm or function 124, also known as a pruner, which is used to reduce the number of calculations performed to find the matching HMM model thereby speeding up the gesture spotting and detection process. For example, given an input sequence which is a sequence of the features from each frame of captured video and a gesture model which is a sequence of states, the corresponding relation between each frame and each state should be found. However, if at some frame, the pruning algorithm or function 124 finds that the cost of matching the frame to any state is too high, then the pruning algorithm or function 124 will stop matching subsequent frames to the states and conclude that the given model doesn't match the input sequence well.

Additionally, the gesture recognition module 112 includes a maximum likelihood linear regression (MLLR) function which is used to adapt the HMM models and incrementally learn the geometrical feature distributions of a specific user for each gesture class. Through simultaneously updating the HMM models and geometrical feature distributions, the gesture recognition system can adapt to the user quickly.

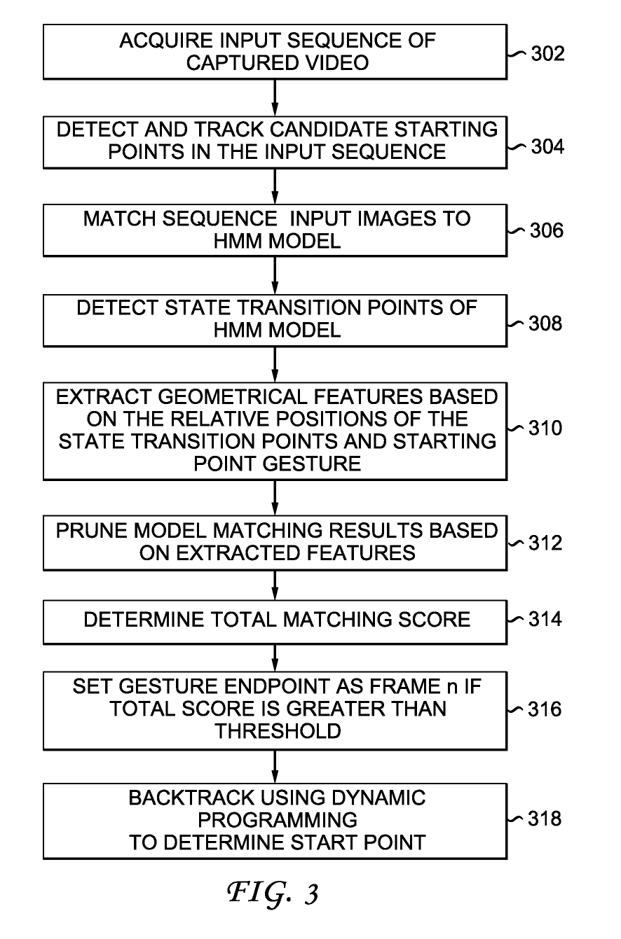

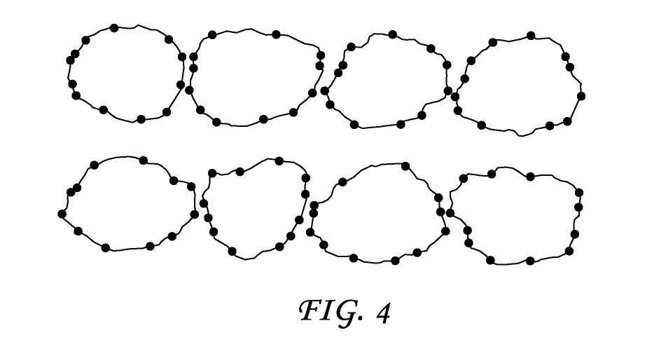

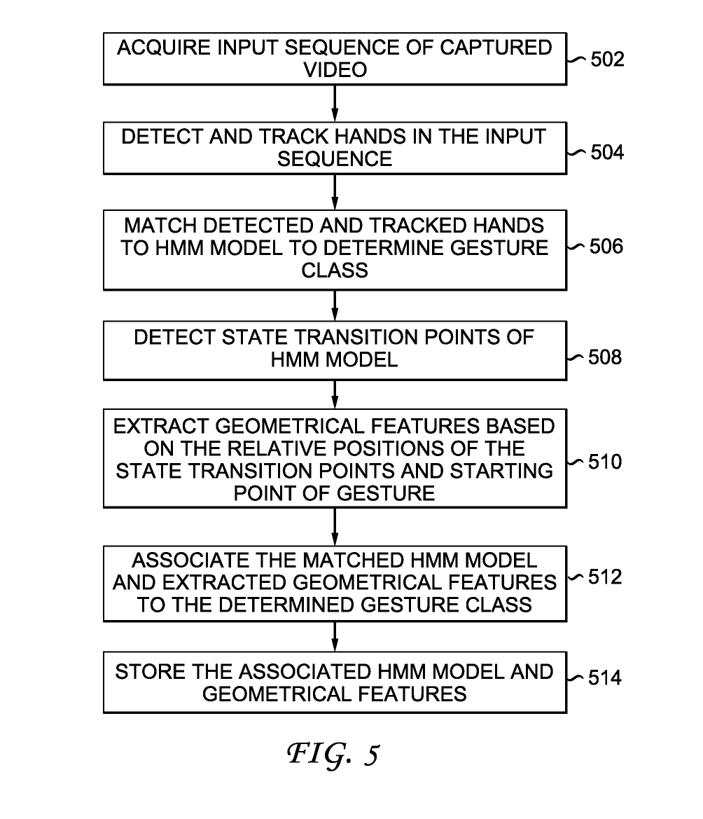

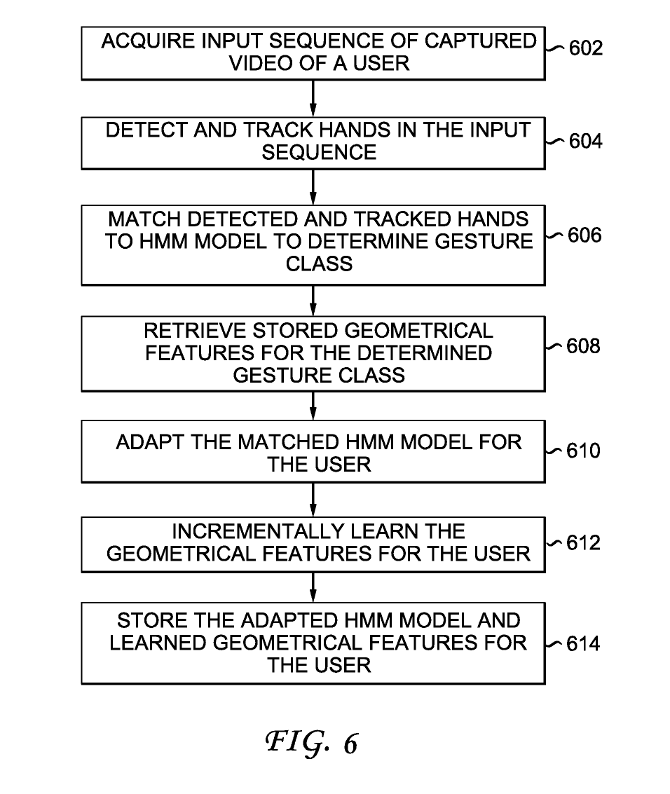

FIG. 2 is a flow diagram of an exemplary method for gesture recognition according to an aspect of the present disclosure. Initially, at step 202 the processing device 104 acquires a sequence of input images captured by the image capture device 102. The gesture recognition module 112 in step 204 then performs gesture recognition using HMM models and geometrical features. Step 204 will be further described below in relation to FIGS. 3-4. In step 206, the gesture recognition module 112 will adapt the HMM models and the geometrical feature distributions for each gesture class for the specific user. Step 206 will be further described below in relation to FIGS. 5-6.

FIG. 3 is a flow diagram of an exemplary method for gesture spotting and recognition according to an aspect of the present disclosure.

### Candidate Starting Points Detection

Initially, in step 302, an input sequence of images is captured by the image capture device 102. In step 304, the object detector and tracker 114 detects candidate starting points in the input sequence and tracks the candidate starting points throughout the sequence. Features such as hand position and velocity are used to represent the hands detected in each frame of the input sequence. These features are normalized by the position and width of the face of the user.

Like direct gesture spotting approaches, candidate starting points are detected as the abrupt changes of motion parameters in the input sequence. The points that have abnormal velocities or severe trajectory curvatures are detected as the candidate starting points. There are usually many false positive detections using this method. Direct gesture spotting methods, which use these points as the gesture boundaries, are not very accurate and robust. The method of the present disclosure uses a different strategy. The hand trajectory is matched to the HMM model of each gesture class from these candidate starting points, so the method can combine the advantages of the direct and indirect gesture spotting methods.

### HMM Model Matching

In step, 306, the sequence of input images are matched to a HMM model 118 via the model matcher 116, as will be described below.

Let Q={Q₁, Q₂, . . . } be a continuous sequence of feature vectors, where Qⱼ is a feature vector extracted from the input frame j of the input images. Features such as hand position and velocity are used to represent the hands detected in each frame. These features are normalized by the position and width of the face of the user performing the gesture. Let M^{g}=[M₀^{g}, . . . , Mₘ^{g}] be a left-right HMM model with m+1 states for gesture g. Each state Mᵢ^{g} is associated with a Gaussian observation density which gives the likelihood of each observation vector Qᵢ. The Baum-Welch algorithm or function will be used to train the HMM model. The number of states for each model is specified according to the trajectory length, as typically done with the Baum-Welch algorithm or function. The transition probabilities are fixed to simplify the learning task, i.e., at every transition, the model is equally likely to move to the next state or to remain at the same state.

Denote a_{k,i} as the transition probability of transitioning from state k to state i, and p(Qⱼ|Mᵢ^{q}) as the likelihood of the feature vector Qⱼ when matching with the model state Mᵢ^{g}. Let C be the candidate starting point set detected using method described in section 1.1. M₀^{g} is a special state where

$$p ( {Q}_{j} \vert {M}_{0}^{g} ) = \{ \begin{matrix}1 , if {Q}_{j} ∈ C \\ 0 , if {Q}_{j} ∉ C\end{matrix} \qquad ( 1 )$$

Thus, the HMM model matching begins only at these candidate starting points. Denote V(i,j) as the maximum probability when matching the first j input feature vectors (Q₁, . . . , Qⱼ) with the first i+1 model states (M₀^{g}, . . . , Mᵢ^{g}). Then we have

$$V ( i , j ) = p ( {Q}_{j} \vert {M}_{i}^{g} ) \cdot {max}_{k} ( {a}_{k , i} V ( k , j - 1 ) ) . \qquad ( 2 )$$

Let the maximum matching score between (Q₁, . . . , Qⱼ) and (M₀^{g}, . . . , Mᵢ^{g}) S_{H}(i,j) be the logarithm of V(i,j):

S_{H}(i,j)=log V(i,j). (3)

Based on the property in Eq. 2, Dynamic Programming (DP) is used to compute the maximum matching score efficiently. DP is implemented using a table, indexed by (i,j). When a new feature vector Qₙ is extracted from the input frame, the slice of the table corresponding to frame n is computed, and two pieces of information are stored at cell (i,n): 1) the value of S_{H}(i,n), for i==0, . . . m, and 2) the predecessor k used to minimize Eq. 2, where S_{H}(i,n) is the score of the optimal matching between the model and the input sequence ending at frame i and k is the state to which the previous frame is corresponding in the optimal matching. S_{H}(m,n) corresponds to the optimal alignment between the model and the input sequence ending at frame n. The optimal Dynamic Programming (DP) path, i.e., the optimal state sequence of HMM model, can be obtained using backtracking. Existing indirect methods usually use S_{H}(m,n) to achieve gesture spotting, i.e., if S_{H}(m,n) is bigger than a threshold, the gesture endpoint is detected as frame n, and the gesture start point can be found by backtracking the optimal DP path.

To improve the speed and accuracy of the system, conventional systems use a pruning strategy, where they prune based on the likelihood of the current observation: If p(Qⱼ|Mᵢ^{g})≦τ(i), where τ(i) is a threshold for model state i and is learned from the training data, the cell (i,j) will be pruned out, and all path going through it will be rejected. However, this simple pruning strategy is not accurate enough.

### Geometrical Feature Extraction

In the method of the present disclosure, the extraction of geometrical features are incorporated into the HMM model matching procedure. For an input sequence, the state sequence of HMM model is determined in step 308, via the transition detector 120. The points where the states of HMM change are detected. FIG. 4 gives some examples of exemplary state transition points extracted from a segmented trajectory “0”, the trajectory being performed by a user and captured by the image capture device 102. The black points are the state transition points. It can be seen that the positions of the state transition points are similar for all the trajectories, so the geometrical features are extracted based on the relative positions of state transition points and the starting point of the gesture, via feature extractor 122 in step 310 as will be described below.

Denote the starting point of the gesture as (x₀, y₀), the geometrical features extracted at transition point (xₜ,yₜ) include: xₜ−x₀, yₜ−y₀, and

$${tan}^{- 1} \frac{{y}_{t} - {y}_{0}}{{x}_{t} - {x}_{0}} .$$

These simple features can well describe the geometrical information of hand trajectories.

For each gesture class, the HMM model associated with it is used to extract the geometrical features of its training samples. The geometrical features are assumed to obey Gaussian distributions. The distributions of geometrical features are learned from the training samples. Then, each gesture class is associated with a HMM model and its geometrical feature distribution. Denote the geometrical feature distributions of gesture g as F^{g}={F₁^{g}, . . . , Fₘ^{g}}, where m is related to the state number of M^{g}, and Fᵢ^{g} is the distribution of geometrical features extracted at point where the state of HMM model changes from i−1 to i. As the extraction of the geometrical features are incorporated into the HMM model matching procedure, it's easy to utilize the geometrical features for pruning. For example, if a frame F is a state transition frame, the geometrical features are extracted based on frame F. If the probability of the extracted geometrical feature is lower than a threshold, this matching will be pruned out, i.e., matching subsequent frames to the states of the model will be stopped by the model matcher 116 and at least one second gesture model to match will be selected. The pruning procedure will now be described in relation to Eq. (4) below.

In step 312, the pruning function or pruner 124 will prune out the cell (i,j) if the following condition is satisfied:

(i≠pre(i) and Fᵢ^{g}(Gⱼ)≦t(j)) or p(Qⱼ|Mᵢ^{g})≦τ(i) (4)

where pre(i) is the predecessor of state i during HMM model matching, Gⱼ is the geometrical features extracted at point j, t(j) is a threshold that learns from the training samples, and p(Qⱼ|Mᵢ^{g}) and τ(i) are defined as in Section 1.2.

In step 314, the total matching score between (Q₁, . . . , Qₙ) and (M₀^{g}, . . . , Mₘ^{g}) is computed as follows by the gesture recognition module 112:

$$S ( m , n ) = α \times {S}_{H} ( m , n ) + ( 1 - α ) \times ( {\sum }_{i = 1}^{m} log {F}_{i}^{g} ( {G}_{j ( i )} ) \qquad ( 5 )$$

where α is a coefficient, S_{H}(m,n) is the HMM matching score, and Gⱼ₍ᵢ₎ is the geometrical features extracted at the point where the HMM state changes from i−1 to i. The temporal segmentation of gesture is achieved like the indirect methods, i.e., if S(m,n) is bigger than a threshold, the gesture endpoint is detected as frame n as in step 216, and the gesture start point can be found by backtracking the optimal DP path as in step 218. By using Expression 4 and Eq. 5, the method can combine HMM and geometrical features of the hand trajectory for gesture spotting and recognition, thus improving the accuracy of the system.

In another embodiment, a system and method for gesture recognition employing Hidden Markov Models (HMM) and geometrical feature distributions to achieve adaptive gesture recognition are provided. The system and method of the present disclosure combine HMM models and geometrical features of a user's hand trajectory for gesture recognition. For an input sequence, a detected object of interest, e.g., a hand, is tracked and matched with a HMM model. Points where the states of HMM model change are found through a Viterbi algorithm or function, a forward algorithm or function, a forward-backward algorithm or function, etc. These points are called state transition points. Geometrical features are extracted based on the relative positions of the state transition points and the starting point of the gesture. Given adaptation data, i.e., the gestures a specific user performed, a maximum likelihood linear regression (MLLR) method is used to adapt the HMM models and incrementally learn the geometrical feature distributions for each gesture class for the specific user. Through simultaneously updating the HMM models and geometrical feature distributions, the gesture recognition system can adapt to the specific user quickly.

### Gesture Recognition Combining HMM and Trajectory Geometrical Features

Referring to FIG. 5, a flow diagram of an exemplary method for training a gesture recognition system using Hidden Markov Models (HMM) and geometrical feature distributions according to an aspect of the present disclosure is illustrated.

Initially, in step 502, an input sequence of images is acquired or captured by the image capture device 102. In step 504, the object detector and tracker 114 detects an object of interest, e.g., a user's hand, in the input sequence and tracks the object throughout the sequence. Features such as hand position and velocity are used to represent the hands detected in each frame of the input sequence. These features are normalized by the position and width of the face of the user. Given the face center position (xf,yf), the width of the face w, and the hand position (xh, yh) on the frame of an image, the normalized hand position is xhn=(xh−xf)/w,yhn=(yh−yf)/w, i.e., the absolute coordinates are changed into relative coordinates with respect to face center.

A left-right HMM model with Gaussian observation densities is used to match the detected hands to a gesture model and determine a gesture class, in step 506. For example, given an input sequence which is a sequence of the features from each frame of the captured video and a gesture model which is a sequence of states, the model matcher 116 finds the corresponding relation between each frame and each state via, for example, the Viterbi algorithm or function, a forward algorithm or function or a forward-backward algorithm or function.

Next, in step 508, for the input sequence, the state sequence of the matched HMM model is detected by the transition detector 120 using a Viterbi algorithm or function. The points where the states of HMM model change are detected. In step 510, the geometrical features are extracted based on the relative positions of state transition points and the starting point of the gesture via the feature extractor 122. Denote the starting point of the gesture as (x₀,y₀), the geometrical features extracted at transition point (xₜ,yₜ) include: xₜ−x₀, yₜ−y₀, and

$${tan}^{- 1} \frac{{y}_{t} - {y}_{0}}{{x}_{t} - {x}_{0}} .$$

Given an input sequence, the features extracted at all the state transition points form the geometrical features of the input sequence. These simple features can well describe the geometrical information of hand trajectories.

For each gesture class, a left-right HMM model is trained, and this HMM model is used to extract the geometrical features of its training samples. The geometrical features are assumed to obey Gaussian distributions. The distributions of geometrical features are learned from the training samples. Then each gesture class is associated with a HMM model and its geometrical feature distribution, in step 512, and the associated HMM model and geometrical feature distribution are stored, step 514.

Denote the HMM model and geometrical feature distribution associated with the ith gesture class are λᵢ and qᵢ, respectively. To match a segmented hand trajectory O−{O₁, O₂, . . . O_{I}} (i.e., the detected and tracked object) with the ith gesture class, the geometrical features G={G₁, G₂, . . . G_{N}} are extracted using λᵢ. The match score is computed by the gesture recognition module 112 as follows:

S=α×log p(O|λᵢ)+(1−α)×log qᵢ(G) (6)

where α is a coefficient and p(O|λᵢ) is the probability of the hand trajectory O given HMM model λᵢ. p(O|λᵢ) can be computed using Forward-Backward algorithm or function. The input hand trajectory will be classified as the gesture class whose match score is the highest. Therefore, using Eq. 6, the system and method of the present disclosure can combine HMM models and geometrical features of the user's hand trajectory (i.e., the detected and tracked object) for gesture recognition.

### The Adaptation of Gesture Recognition

FIG. 6 is a flow diagram of an exemplary method for adapting a gesture recognition system to a specific user according to an aspect of the present disclosure. Given adaptation data (i.e., the gestures a specific user performed), the system and method of the present disclosure employ a maximum likelihood linear regression (MLLR) function to adapt the HMM models and incrementally learn the geometrical feature distributions for each gesture class.

Initially, in step 602, an input sequence of images is captured by the image capture device 102. In step 604, the object detector and tracker 114 detects an object of interest in the input sequence and tracks the object throughout the sequence. A left-right HMM model with Gaussian observation densities is used to model a gesture class, in step 606. In step 608, the geometrical feature distributions associated to the determined gesture class are retrieved.

Next, in step 610, the HMM model is adapted for the specific user using the maximum likelihood linear regression (MLLR) function. Maximum likelihood linear regression (MLLR) is widely used for adaptive speech recognition. It estimates a set of linear transformations of the model parameters using new samples, so that the model can better match the new samples after transformation. In the standard MLLR approach, the mean vectors of the Gaussian densities are updated according to

μ̅=Wξ (7)

where W is an n×(n+1) matrix (and n is the dimensionality of the observation feature vector) and ξ is the extended mean vector: ξ^{T}=[1, μ₁, . . . , μₙ]. Assume the adaptation data, O, is a series of T observations: O=o₁ . . . o_{T}. To compute W in Eq. 7, the objective function to be maximized is the likelihood of generating the adaptation data:

$$F ( O \vert λ ) = {\sum }_{θ} F ( O , θ \vert λ ) \qquad ( 8 )$$

where θ is the possible state sequence generating O, λ is the set of model parameters. By maximizing the auxiliary function

$$Q ( λ \overline{λ} ) = {\sum }_{θ} F ( O , θ \vert λ ) log F ( O , θ \vert \overline{λ} ) \qquad ( 9 )$$

where λ is the current set of model parameters, and λ̅ is the re-estimated set of model parameters, the objective function in Eq. 8 is also maximized Maximizing Eq. 9 with respect to W can be solved with the Expectation-Maximization (EM) algorithm or function.

Then, in step 612, the system incrementally learns the geometrical feature distributions for the user by re-estimating a mean and covariance matrix of the geometrical feature distribution over a predetermined number of adaptation samples. Denote current geometrical feature distributions of gesture g as F^{g}={F₁^{g}, . . . , Fₘ^{g}}, where Fᵢ^{g} is the distribution of geometrical features extracted at the point where the state of the HMM model changes from i−1 to i. Assume the mean and the covariance matrix of Fᵢ^{g} are μᵢ^{g} and Σᵢ^{g}, respectively. Given the adaptation data of gesture g, geometrical features are extracted from the data, and let the geometrical features extracted at points of the adaptation data where the state changes from i−1 to i form the set X={x₁, . . . xₖ}, where xᵢ is the features extracted from the ith adaptation sample of gesture g, and k is the number of adaptation samples for gesture g. Then, the geometrical feature distribution is updated as follows:

$$\begin{matrix} & ( 10 ) \\ \{ \begin{matrix}\begin{matrix}\overline{{u}_{i}^{g}} = β \cdot {u}_{i}^{g} + ( 1 - β ) \cdot {\sum }_{l = 1}^{k} {x}_{l} / k \\ \end{matrix} \\ \overline{{Σ}_{i}^{g}} = β \cdot {Σ}_{i}^{g} + ( 1 - β ) \cdot {\sum }_{l = 1}^{k} {( ( {( x )}_{l} - \overline{{u}_{i}^{g}} ) {( x )}_{l} - \overline{{u}_{i}^{g}} )}^{T} / ( k - 1 )\end{matrix} & \end{matrix}$$

where μ̅ᵢ̅^̅{̅g̅}̅ and Σ̅ᵢ̅^̅{̅g̅}̅ are the re-estimated mean and covariance matrix of Fᵢ^{g} respectively.

Through simultaneously updating the HMM models and geometrical feature distributions, the gesture recognition system can adapt to the user quickly. The adapted HMM model and learned geometrical feature distributions in step 614 are then stored for the specific user in storage device 110.

A system and method for gesture recognition has been described. Gesture models (e.g., HMM models) and geometrical feature distributions are used to perform the gesture recognition. Based on adaptation data (i.e., the gestures a specific user performed), both the HMM models and geometrical feature distributions are updated. In this manner, the system can adapt to the specific user.

In the playback device 700 shown in FIG. 7, image information and corresponding information used for purchasing items are received via input signal receiver 702. The input signal receiver 702 can be one of several known receiver circuits used for receiving, demodulation, and decoding signals provided over one of the several possible networks including over the air, cable, satellite, Ethernet, fiber and phone line networks. The desired input signal can be selected and retrieved in the input signal receiver 702 based on user input provided through a control interface (not shown). The decoded output signal is provided to an input stream processor 704. The input stream processor 704 performs the final signal selection and processing, and includes separation of video content from audio content for the content stream. The audio content is provided to an audio processor 706 for conversion from the received format, such as compressed digital signal, to an analog waveform signal. The analog waveform signal is provided to an audio interface 708 and further to a display device or an audio amplifier (not shown). Alternatively, the audio interface 708 can provide a digital signal to an audio output device or display device using a High-Definition Multimedia Interface (HDMI) cable or alternate audio interface such as via a Sony/Philips Digital Interconnect Format (SPDIF). The audio processor 706 also performs any necessary conversion for the storage of the audio signals.

The video output from the input stream processor 704 is provided to a video processor 710. The video signal can be one of several formats. The video processor 710 provides, as necessary a conversion of the video content, based on the input signal format. The video processor 710 also performs any necessary conversion for the storage of the video signals.

Storage device 712 stores audio and video content received at the input. The storage device 712 allows later retrieval and playback of the content under the control of a controller 714 and also based on commands, e.g., navigation instructions such as next item, next page, zoom, fast-forward (FF) playback mode and rewind (Rew) playback mode, received from a user interface 716. The storage device 712 can be a hard disk drive, one or more large capacity integrated electronic memories, such as static random access memory, or dynamic random access memory, or can be an interchangeable optical disk storage system such as a compact disk drive or digital video disk drive. In one embodiment, the storage device 712 can be external and not be present in the system.

The converted video signal, from the video processor 710, either originating from the input or from the storage device 712, is provided to the display interface 718. The display interface 718 further provides the display signal to a display device of the type described above. The display interface 718 can be an analog signal interface such as red-green-blue (RGB) or can be a digital interface such as high definition multimedia interface (HDMI).

Controller 714, which can be a processor, is interconnected via a bus to several of the components of the device 700, including the input stream processor 702, audio processor 706, video processor 710, storage device 712, user interface 716, and gesture module 722. The controller 714 manages the conversion process for converting the input stream signal into a signal for storage on the storage device or for display. The controller 714 also manages the retrieval and playback modes used for the playback of stored content. Furthermore, as will be described below, the controller 714 performs searching of content, either stored or to be delivered via the delivery networks described above. The controller 714 is further coupled to control memory 720 (e.g., volatile or non-volatile memory, including random access memory, static RAM, dynamic RAM, read only memory, programmable ROM, flash memory, EPROM, EEPROM, etc.) for storing information and instruction code for controller 714. Further, the implementation of the memory can include several possible embodiments, such as a single memory device or, alternatively, more than one memory circuit connected together to form a shared or common memory. Still further, the memory can be included with other circuitry, such as portions of bus communications circuitry, in a larger circuit.

User interface 716 of the present disclosure can employ an input device that moves a cursor around the display, which in turn causes the content to enlarge as the cursor passes over it. In one embodiment, the input device is a remote controller, with a form of motion detection, such as a gyroscope or accelerometer, which allows the user to move a cursor freely about a screen or display. In another embodiment, the input device is controllers in the form of touch pad or touch sensitive device that will track the user's movement on the pad, on the screen. In another embodiment, the input device could be a traditional remote control with direction buttons. User interface 716 can also be configured to optically recognize user gestures using a camera, visual sensor, and the like in accordance with the exemplary principles described therein the specification.

Gesture module 722, as an exemplary embodiment from FIG. 1, interprets gesture based input from user interface 716 and determines what gesture a user is making in accordance with the exemplary principles above. The determined gesture then can be used to set forth a playback and a speed for the playback. Specifically, a gesture can be used to indicate the playback of media at a faster than real time playing of media such as a fast forward operation and a fast reverse operation. Likewise, a gesture can also indicate a slower than real time playing of media such as a slow motion forward operation and a slow motion reverse operation. Such determinations of what gestures mean and how such gestures control the playback speed of media are described in various illustrative embodiments.

Gestures can be broken down into at least two parts which are known as a base gesture and a gesture modifier. A base gesture is a “gross” gesture which encompasses an aspect of movement which can be the movement of an arm or a leg. A modifier of a gesture can be the number of fingers that are presented while a person is moving an arm, the position of a presented finger on a hand when a person is moving an arm, the movement of a foot when a person is moving their leg, the waving of a hand while a person is moving an arm, and the like. A base gesture can be determined by gesture module 722 as to operate playback device 700 in a playback mode such as fast forward, fast reverse, slow motion forward, slow motion reverse, normal play, pause, and the like. The modifier of the gesture is then determined by gesture module 720 as to set the speed of playback which can be faster or slower than the real time playing of media associated with a normal play mode. In an exemplary embodiment, playback associated with a particular gesture will continue for as long as that gesture is held by a user.

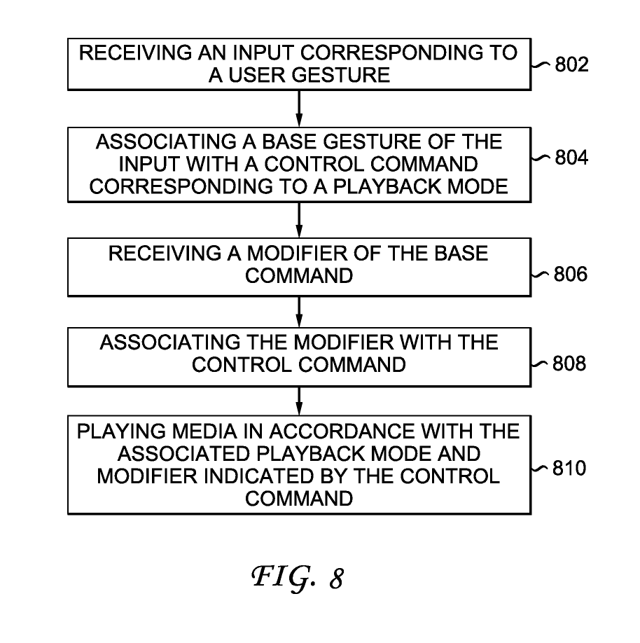

FIG. 8 illustrates a flow diagram 800 where input gestures are used to control the playback of media in accordance with an exemplary embodiment. Step 802 has user interface 710 receiving a user gesture. As described above, a user gesture can be recognized by user interface 710 using a visual technique. In step 804, gesture module 722 breaks down the input gesture into a base gesture which illustratively can be a moving of an arm in a left direction, a moving of an arm in a right direction, a moving of arm in a upward direction, moving an arm in a downward direction, and the like. The determined base gesture is then associated with a control command which is used to select a playback mode using illustrative playback modes such as a normal play mode, fast forward, fast reverse, slow forward motion, slow reverse motion, pause mode, and the like. A playback mode can be a real time playback mode which is a real time play operation. A playback mode can also be a non-real time playback mode which is using a playback mode such as fast forward, fast reverse, slow motion forward, slow motion reverse, and the like. In an exemplary embodiment, a movement of an arm in a right direction indicates a forward playback operation while the movement of an arm in a left direct indicates a reverse playback operation.

Step 806 has gesture module 722 determine a modifier of the base gesture where illustrative modifiers include the number of fingers presented on a hand, the position of a finger on a hand, a number of waves of a hand, a movement of a finger of a hand, and the like. In an illustrative example, a first finger can indicate a first playback speed, a second finger can indicate a second playback speed, a third finger can indicate a third playback speed, and the like. Ideally, the modifier corresponds to a playback speed which is faster or slower than non-real time.

In another illustrative example, the position of an index finger can represent a two times faster than real time playback speed, the position of a middle finger can represent a four times faster than real time playback speed, the position of the ring finger can represent an eight times faster than real time playback speed, and the like.

The speeds that correspond to the different modifiers can be a mix of faster and slower than real time speeds. In a further illustrative example, the position of an index finger can represent a two times faster than real time playback speed while a position of a middle finger can represent a one half times real time playback speed. Other mixes of speeds can be used in accordance with the exemplary principles.

In step 808, the modifier determined by gesture module 722 is associated with a control command which determines the speed of the playback mode from step 806. In step 810, controller 714 uses the control command to initiate the playback of media in the determined playback mode at a speed determined by the modifier. The media can be outputted in the determined playback mode via audio processor 706 and video processor 710 in accordance with the selected playback mode.

In an optional embodiment, a change from a fast speed operation to a slow speed motion mode can be accomplished by moving an arm in a downward direction. That is, the base gesture that is used to cause a fast forward operation would now result in a slow forward motion operation while the base gesture that resulted in a fast reverse operation would now result in a slow motion reverse operation. In a further optional embodiment, a change from a slow speed operation to a fast speed operation for a base gesture is performed in response to gesture moving an arm in an upward direction in accordance with the illustrative principles.

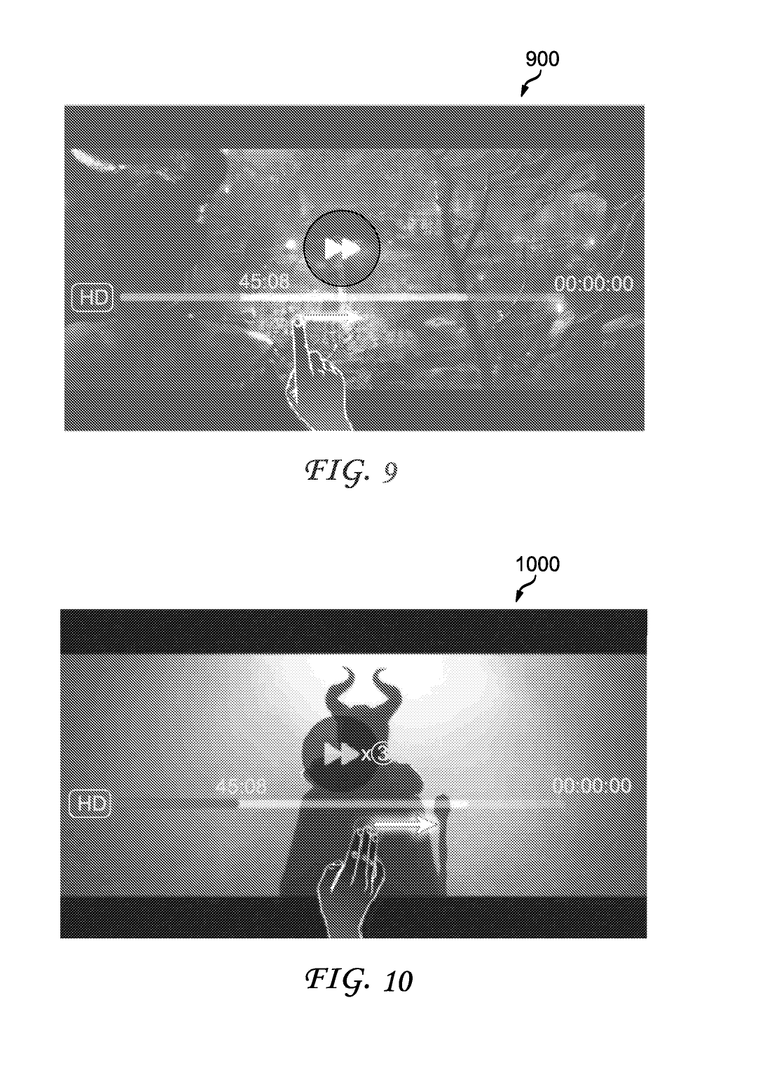

FIG. 9 presents an exemplary embodiment of a user interface 900 that shows a representation of an arm and hand gesture used to control the playback of media. The specific gesture in user interface 900 shows an arm towards the right using one finger. The base gesture of the arm movement to the right would indicate a fast forward or a slow motion forward playback of media where the modifier indicates that media should be played back at a first speed. FIG. 10 presents an exemplary embodiment of a user interface 1000 that shows an arm and hand gesture moving towards the right where the playback of media would be at a third speed which correlates to the display of three fingers as a modifier.

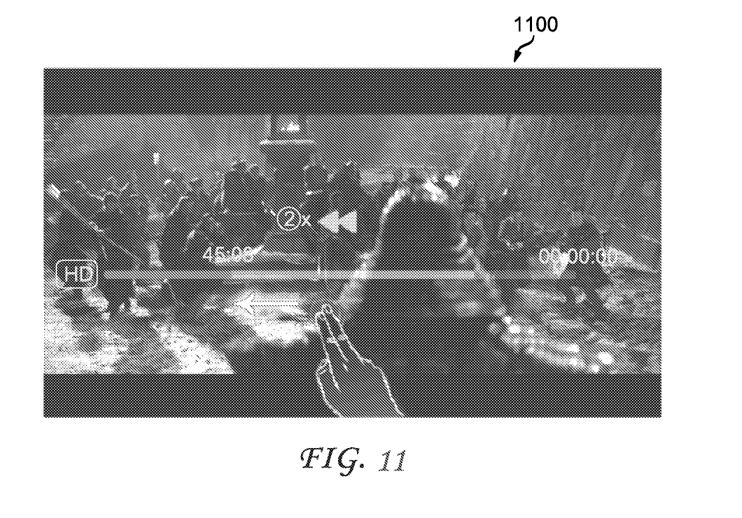

FIG. 11 presents an exemplary embodiment of a user interface 1100 that illustrates an arm and hand gesture being used to control the playback of media. Specifically, the gesture in user interface 1100 is a base gesture moving towards the left which correlates to the playback of media in a reverse based mode either being a fast reverse or a slow motion review. The speed of the reverse based mode is a second speed from a plurality of speeds, in accordance with the exemplary principles. Table 1 below shows exemplary base gestures with associated modifiers in accordance with the disclosed principles.

TABLE 1

| Base Gesture | Gesture Modifier | Action |
|---|---|---|
| Arm Moving to Right | Fingers Shown | Forward Mode, Different Speeds |
| | | Depending on Number of Fingers |
| | | Shown |
| Arm Moving to Left | Fingers Shown | Reverse Mode, Different Speeds |
| | | Depending on Number of Fingers |
| | | Shown |
| Arm Moving to Right | A Specific Finger Shown | Forward Mode, Speed Depends |
| | | on the Position of Finger Shown |
| Arm Moving to the Left | A Specific Finger Shown | Reverse Mode, Speed Depends |
| | | on the Position of the Finger |
| | | Shown |
| Arm Moving to Right | Number of Hand Waves | Forward Mode, Number of Hand |
| | | Waves Determines Speed |
| Arm Moving to the Left | Number of Hand Waves | Reverse Mode, Number of Hand |
| | | Waves Determines Speed |
| Arm Moving to the Right | Movement of a Finger | Forward Mode, Specific |
| | (drawing 1, 2, 3, etc. as a | Movement of Finger |
| | gesture) | Determines Speed |
| Arm Moving to the Left | Movement of a Finger | Reverse Mode, Specific |
| | (drawing 1, 2, 3, etc. as a | Movement of Finger |
| | gesture) | Determines Speed |
| Palm Being Shown | N/A | Pause Mode |
| Fist Being Shown | N/A | Play Mode |

Although embodiments which incorporate the teachings of the present disclosure have been shown and described in detail herein, those skilled in the art can readily devise many other varied embodiments that still incorporate these teachings. Having described preferred embodiments for a system and method for gesture recognition (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the disclosure as outlined by the appended claims.

1. A method for controlling media playback, comprising:
receiving an input corresponding to a user gesture;
associating a base gesture of the input with a control command corresponding to a playback mode;
receiving a modifier of the base gesture;
associating the modifier with the control command; and
playing media in accordance with the associated playback mode and modifier in response to said control command.

2. The method of claim 1, further comprising:
selectively associating one of a plurality of different modifiers with the control command; and
modifying the playback mode in response to the selected one of said plurality of said modifiers.

3. The method of claim 2, further comprising selecting different ones of the plurality of said modifiers to control the direction and speed of the playback mode.

4. The method of claim 1, wherein the playback mode is at least one mode selected from a group comprising of a fast forward operation, a fast reverse operation, a slow motion forward operation, and a slow motion reverse operation.

5. The method of claim 1, wherein the base gesture is at least one gesture selected from a group comprising of moving an arm towards a left direction, moving an arm towards the right direction, moving an arm in an upward direction, and moving an arm in a downward direction.

6. The method of claim 5, wherein the modifier of the base gesture is at least one element selected from a group comprising presenting at least one finger, a position of at least one presented finger; at least one hand wave, and at least one movement of at least one finger.

7. The method of claim 6, wherein the presenting of at least one finger further comprises:
the presenting of one finger represents a first speed for a playback speed;
the presenting of a two fingers represents a second speed for a playback speed; and
the presenting of a three fingers represents a third speed for a playback speed.

8. The method of claim 6, wherein the presenting of at least one finger further comprises:
the presenting of the finger at a first position represents a speed at a first playback speed;
the presenting of the finger at a second position represents a speed at a second playback speed; and
the presenting of the finger at a third position represents a speed at a third playback speed.

9. The method of claim 5, wherein the moving of the arm in a downward direction changes the playback speed from a fast speed operation to a slow motion operation.

10. The method of claim 5, wherein the moving of the arm in a upward direction changes the playback speed from a slow motion operation to a fast speed operation.

11-14. (canceled)

15. An apparatus for controlling media playback, comprising:
a processor; and
a memory coupled to the processor, the memory for storing instructions which, when executed by the processor, perform the operations of:
receiving an input corresponding to a user gesture;
associating a base gesture of the input with a control command corresponding to a playback mode;
receiving a modifier of the base gesture;
associating the modifier with the control command; and
playing media in accordance with the associated playback mode and modifier in response to said control command.

16. The apparatus of claim 15 comprising instructions causing the processor to perform the operations of:
selectively associating one of a plurality of different modifiers with the control command; and
modifying the playback mode in response to the selected one of said plurality of said modifiers.

17. The apparatus of claim 16, further comprising an instruction causing the processor to perform the operation of selecting different ones of the plurality of said modifiers to control the direction and speed of the playback mode.

18. The apparatus of claim 15, wherein the playback mode is at least one mode selected from a group comprising of a fast forward operation, a fast reverse operation, a slow motion forward operation, and a slow motion reverse operation.

19. The apparatus of claim 15, wherein the base gesture is at least one gesture selected from a group comprising of moving an arm towards a left direction, moving an arm towards the right direction, moving an arm in an upward direction, and moving an arm in a downward direction.

20. The apparatus of claim 19, wherein the modifier of the base gesture is at least one element selected from a group comprising presenting at least one finger, a position of at least one presented finger; at least one hand wave, and at least one movement of at least one finger.

21. The apparatus of claim 20, wherein the presenting of at least one finger further comprises:
the presenting of one finger represents a first speed for a playback speed;
the presenting of a two fingers represents a second speed for a playback speed; and
the presenting of a three fingers represents a third speed for a playback speed.

22. The apparatus of claim 20, wherein the presenting of at least one finger further comprises:
the presenting of the finger at a first position represents a speed at a first playback speed;
the presenting of the finger at a second position represents a speed at a second playback speed; and
the presenting of the finger at a third position represents a speed at a third playback speed.

23. The apparatus of claim 19, wherein the moving of the arm in a downward direction changes the playback speed from a fast speed operation to a slow motion operation.

24. The apparatus of claim 19, wherein the moving of the arm in a upward direction changes the playback speed from a slow motion operation to a fast speed operation.

25-28. (canceled)
